(19) United States
(12) Patent Application Publication
(10) Pub. No.: US 2026/0257315 A1
(43) Pub. Date: Sep. 3, 2026

(54) A VIBRATING MACHINE CONDUCTING FINE SANDING WITH AT LEAST ONE DETECTOR UNIT

(71) Applicant: KARABUDAK MÜHENDISLIK MAKINA IMALAT SANAYI LTD.STI., Gebze/Kocaeli (TR)

(72) Inventor: Ejder BAYIR, Çekmeköy/Istanbul (TR)

(73) Assignee: KARABUDAK MÜHENDISLIK MAKINA IMALAT SANAYI LTD.STI., Gebze/Kocaeli (TR)

(21) Appl. No.: 18/877,744

(22) PCT Filed: Dec. 28, 2022
(86) PCT No.: PCT/TR2022/051655

§ 371 Date: Dec. 20, 2024

(51) Int. Cl. B24B 49/12; B24B 7/12

(52) U.S. Cl. CPC B24B 49/12; B24B 7/12

(57) ABSTRACT

The invention has been developed to conduct orbital sanding process in the woodworking industry with high precision and pertains to a vibrating machine comprising; at least one camera background plate, at least one lighting unit, at least one angle adjustment unit, at least one dark unit, at least one Camera/Lidar sensor unit, at least one sanding pad, at least on driving unit, at least one shock-absorbing wedge, at least one pneumatic piston, and at least one vibration unit.

### TECHNICAL FIELD

The invention pertains to a vibrating sanding machine and camera scanning unit developed to ensure the execution of high precision orbital sanding process in woodworking industry.

### PRIOR ART

In the presently known state of the technique, sensors and sensor groups with low geometric detecting precision, commonly used in the automation industry, are among the systems employed. The stated sensors provide no response to the object detection approach other than existent/non-existent, cannot define the geometric features of the product and cannot present the visual data of the detected product. Detection with a precision required particularly for the sanding process cannot be ensured depending on the installation of the sensors. In addition to the requirement for the utilized sensor groups to comprise dozens of sensors, there are also disadvantages such as difficulties caused by the need to employ several modules required for installation, wiring and communication of the sensors.

For reasons listed above, there is need to develop vibrating sanding machines comprising advanced detection units that could be used in woodworking machines and that could prevent the occurrence of the afore-mentioned problems and disadvantages.

### SUMMARY OF THE INVENTION

A purpose of the invention is to develop a machine that detects the objects placed in the machine with higher precision and accuracy through the processing, with digital image processing and point cloud segmentation methods, of the data acquired via digital camera and LIDAR, instead of the common detection sensors used in woodworking machines.

Another purpose of the invention is to develop a machine that conducts fast and high-accuracy analyses on the geometric specifications of the detected products together with their raster and vectorial data and decides, depending on the analysis, how the product is to be processed.

Another purpose of the invention is to ensure the integration of woodworking machines with digital image processing technology and LIDAR. It is intended through this integration to recognize the objects with much higher precision and to acquire the object's geometric specifications (inner pattern, quadrilateral, polygon, circle, area, periphery, etc.).

Another purpose of the invention is to acquire real time images of the objects being processed in the machine. Likewise, it is intended to acquire data for quality control studies, sensitive to ±0.01 mm in both axes.

### DESCRIPTION OF FIGURES

FIG. 1: A figurative perspective view of the machine subject to invention

FIG. 2: A figurative plan view of the machine subject to invention

FIG. 3: A figurative side view of the machine subject to invention

FIG. 4: A figurative front view of the machine subject to invention

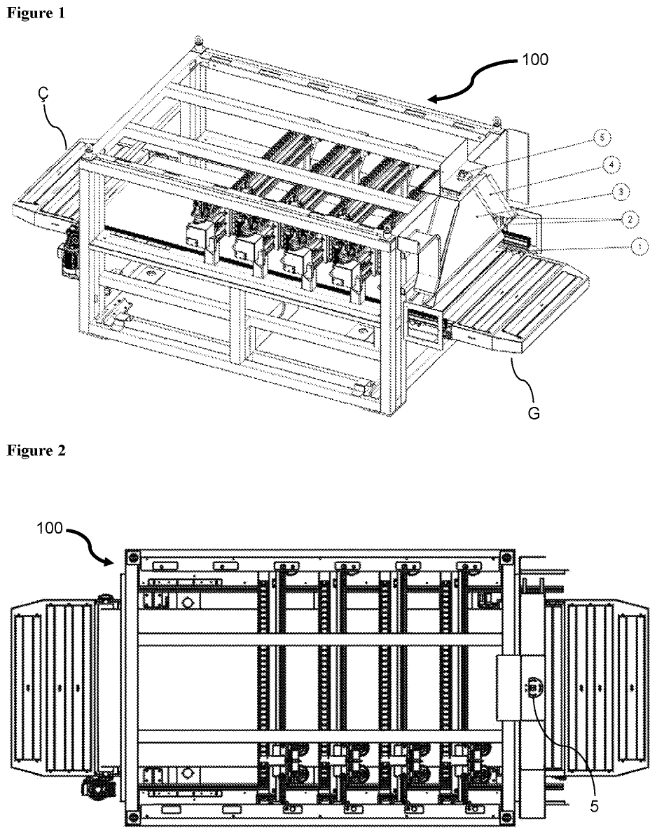

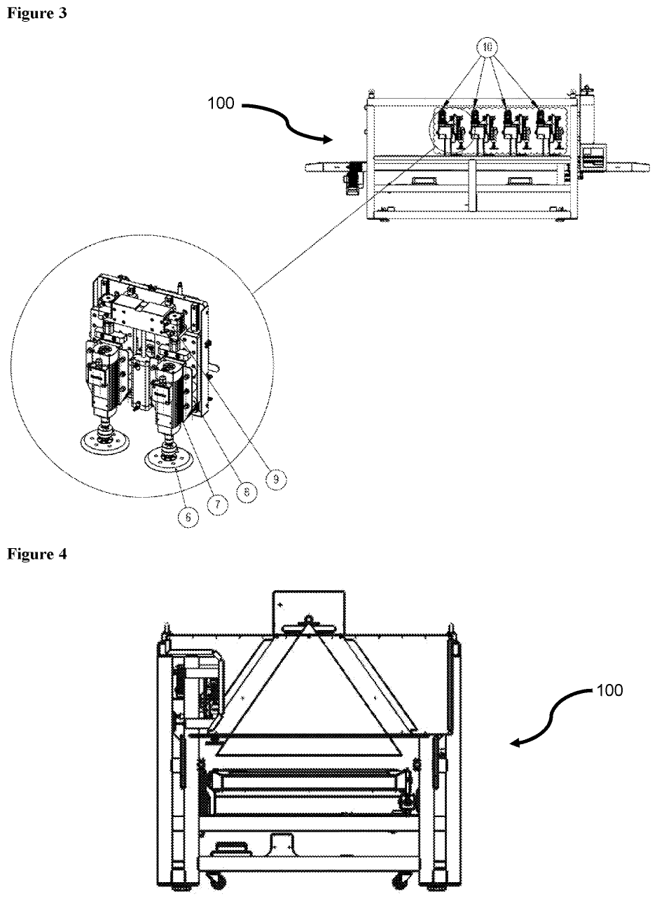

### DESCRIPTION OF THE REFERENCES IN FIGURES

The numbers in the drawings are provided below in order to provide a better understanding of the invention:
100. Machine 1. Camera background plate
   2. Lighting unit
   3. Angle adjustment unit
   4. Dark Unit
   5. Camera/Lidar sensor unit
   6. Sanding pad
   7. Driving unit
   8. Shock-absorbing wedge
   9. Pneumatic piston
   10. Vibration unit
   G. Entrance
   C. Exit

### DETAILED DESCRIPTION OF THE INVENTION

The vibrating sanding machine subject to invention (100) comprises, at least one camera background plate (1) that ensures the formation of the background through creation of contrast in the images of at least one product to be processed, at least one lightning unit (2) with pre-defined color temperature and kelvin values that provides the required lighting during the camera exposure, at least one angle adjustment unit (3) that ensures the adjustment of perspective depending on the distance of the Camera/Lidar sensor unit (5) to the camera background plate (1), at least one dark unit (4) that provides a dust-free setting for the images to be retrieved and prevents external light sources, at least one Camera/Lidar sensor unit (5) with camera and/or LIDAR and located at the entrance (G) of the machine (100), which ensures the detection and 2 dimensional and/or 3 dimensional modelling of the products entering the machine (100) and ensures quality control of the entering and exiting products, at least one sanding pad (6) with orbital vibration feature to touch upon the product and perform sanding, at least one driving unit (7) with a spindle engine to spin in high speed (up to 12000 rpm) and/or vibrate the mentioned sanding pads (6), at least one shock-absorbing wedge (8) made of elastomer to stem the transmission of the vibration caused by the operation of the driving unit (7) to the machine (100), at least one pneumatic piston (9) to ensure that the stated sanding pads (6) apply equal pressure to all points on the product, at least one vibration unit (10) and a conveyor (not assigned a number) to ensure that the stated sanding pads (6) follow the sanding route.

The stated pneumatic piston (9) ensures the precise execution of the sanding process by stabilizing the pressure through change of position on undulating product surface.

The stated vibration unit (10), together with 8 sanding pads placed in 2×4 formation, follows the sanding route to be tracked on the product and performs the sanding move. Vibration unit (10) is a unit that is designed as a robotic arm and performs automatic route tracking through a software pre-installed to the machine (100).

The Camera/Lidar sensor unit (5) located at the entrance (G) of the machine (100) is the KAMA-VISION digital visual processing unit, in the preferred application of the invention. The stated Camera/Lidar sensor unit (5), gathers the relevant products/pieces' data such as area, side lengths, shapes, color through capturing the image of the product in 20 milliseconds and processing these images in 120 milliseconds. The algorithms (filtering, refraction, spectral and geometric correction, coordinate transformation) used for processing of the images have been custom developed within the Camera/Lidar sensor unit (5), that is KAMA-VISION unit, to synchronize with the machine (100). One digital camera and an IPC (Inter Process Communication) to which that camera is connected suffices to process the images and the processes are performed via the stated IPC without need for an additional processing unit. The detection precision accomplished through the processing of the images acquired via a camera preferably with at least 8-megapixel is ±0.001 mm. In addition to the digital camera located within the stated Camera/Lidar sensor unit (5), LIDAR sensors are used in another application of the invention. Thus, 3 dimensional object data are segmented and work orders are forwarded to vibration units (10) in accordance with the output obtained. The stated transactions are dynamically executed without the need to stop the machine (100) conveyor. The images captured and processed with KAMA-VISION digital image processing unit, are used for 3 dimensional modeling of the of the pieces entering the machine (100) and selection of the areas to be/not to be sanded on the modelled image of the pieces via the machine (100) screen.

In an application of the invention, the machine (100) functions as specified below:

Products to be processed enter the machine (100). Images are captured during the passage of the products through the Camera/Lidar sensor unit located at the machine (100) entrance (G). During the capturing of the images, camera background plate (1) ensures that the back ground is clean and lightning unit (2) creates the necessary bright ambient to ensure a clear image. The orientation of the images and adjustment of the perspective of the camera is ensured with the angle adjustment unit (3). Dark unit (4), on the other hand, prevents the external light coming from outside. The dynamically captured images are first kept subject to cropping and rotation procedures and then spectral adjustment of the stated images is automatically conducted by the machine's (100) own algorithm. Following this, the geometric adjustment of the stated images is conducted and then object recognition algorithms predefined to the machine (100) are applied on the image that has completed pre-processing. Products/pieces passing under the Camera/Lidar sensor unit (5) are defined with all their geometric specifications. This geometry acquired on the photographic coordinate system is then transformed into metric coordinate system for the movements of the sanding pads (6). Following the detection of the geometry, the sanding routes to be observed during the processing of the product are formed by the stated software installed on the machine (100) and sanding route information to be observed for fine sanding is forwarded to the vibration unit (10). Thus, sanding pads (6) conduct the sanding process with precision.

Contrary to the sensors (±3 cm) used in the presently known state of technique, the digital image processing system used in the wood processing machine (100) conducts the object recognition and sanding processes of the of the machine with higher precision (±0.01 mm) and lower cost.

Since the information such as the dimension, color and texture of the products are also geometrically and spectrally detected and processed by the invention, the quality control processes too are conducted by the machine (100).

### INDUSTRIAL APPLICABILITY OF THE INVENTION

The invention pertains to a vibrating sanding machine (100) developed to conduct orbital sanding process in the woodworking industry with high precision and is applicable to the industry.

The invention is not limited to the afore-submitted explanations, and one with specialty in the technique can easily introduce different applications of the invention. These should be considered within the scope of the protection requested with the demands.

1. A vibrating sanding machine with at least one conveyor,
developed to be used in the woodworking industry;
characterized in that it comprises at least one camera background plate that ensures the formation of the background through creation of contrast in the images of at least one product to be processed, at least one lighting unit with pre-defined color temperature and kelvin values that provides the required lighting during the camera exposure, at least one angle adjustment unit that ensures the adjustment of perspective depending on the distance of the Camera/Lidar sensor unit to the camera background plate, at least one dark unit that provides a dust-free setting for the images to be retrieved and prevents external light sources, at least one Camera/Lidar sensor unit with camera and/or LIDAR and located at the entrance of the machine, which ensures the detection and 2 dimensional and/or 3 dimensional modelling of the products entering the machine and ensures quality control of the entering and exiting products, at least one sanding pad with orbital vibration feature to touch upon the product and perform sanding, at least on driving unit with a spindle engine to spin in high speed (up to 12000 rpm) and/or vibrate the mentioned sanding pads, at least one shock-absorbing wedge made of elastomer to stem the transmission of the vibration caused by the operation of the driving unit to the machine, at least one pneumatic piston to ensure that the stated sanding pads apply equal pressure to all points on the product, and at least one vibration unit to ensure that the stated sanding pads follow the sanding route.
